(19) United States
(12) Patent Application Publication
(10) Pub. No.: US 2023/0224571 A1
(43) Pub. Date: Jul. 13, 2023

(54) IMAGING ASSISTANCE CONTROL APPARATUS, IMAGING ASSISTANCE CONTROL METHOD, AND IMAGING ASSISTANCE SYSTEM

(71) Applicant: SONY GROUP CORPORATION, Tokyo (JP)

(72) Inventors: Ayumi NAKAGAWA, Kanagawa (JP); Takeshi OGITA, Kanagawa (JP); Ryo YOKOYAMA, Tokyo (JP); Manabu FUJIKI, Tokyo (JP); Kazuki NAKAMURA, Tokyo (JP)

(73) Assignee: SONY GROUP CORPORATION, Tokyo (JP)

(21) Appl. No.: 18/009,538

(22) PCT Filed: Jun. 22, 2021
(86) PCT No.: PCT/JP2021/023607

§ 371 Date: Dec. 9, 2022

(30) Foreign Application Priority Data
Jul. 14, 2020 (JP) 2020-120697

(51) Int. Cl. H04N 23/63; H04N 23/69; G06F 3/01; G06F 3/16

(52) U.S. Cl. CPC H04N 23/631; H04N 23/69; G06F 3/016; G06F 3/167

(57) ABSTRACT

An imaging assistance control apparatus according to the present technology includes a control unit that performs control such that guidance regarding a composition change operation by a user is performed by tactile presentation to the user on the basis of a difference between a target composition and an actual composition.

### TECHNICAL FIELD

The present technology relates to a technical field of an imaging assistance control apparatus that perform control such that guidance regarding a composition change operation by a user is performed and a method of the same, and an imaging assistance system including the imaging assistance control apparatus.

### BACKGROUND ART

Imaging assistance technologies for assisting a user regarding image capturing using a camera have been proposed. For example, Patent Document 1 below discloses a technology of performing voice guidance regarding a composition change operation by a user so as not to cause an inappropriate composition.

### CITATION LIST

### Patent Document

Patent Document 1: Japanese Patent Application Laid-Open No. 4135100

### SUMMARY OF THE INVENTION

### Problems to be Solved by the Invention

Here, there is a demand for execution of imaging without gazing at a screen of a camera. For example, when a pet or a child is imaged, there is a demand for execution of imaging while viewing with naked eyes rather than through a screen.

Furthermore, among people with visual impairment, there is a person having a desire to execute imaging with a camera depending on the degree of the impairment. In this case, it is expected that a user is not able to accurately grasp a position and a size of a subject on a screen and the imaging becomes difficult.

In regard to these demands, performing the guidance by voice as in Patent Document 1 is considered to be effective, but there is a case where the guidance by voice is not suitable depending on a situation in which imaging is performed. For example, there is a case where a user is not able to hear the guidance by voice in a noisy situation in the surroundings outdoors or in a noisy situation in which a running child is imaged even indoors.

Furthermore, the guidance by voice is not suitable in a situation in which quietness is required either, for example, a situation in which a wild animal, such as a wild bird, is imaged, and the like. Moreover, it is not desirable to record unnecessary voice at the time of moving image capturing, so that the guidance by voice is not suitable.

The present technology has been made in view of the above-described circumstances, and an object thereof is to improve imaging assistance performance by enabling execution of appropriate imaging assistance even in a case where guidance by a display or sound is not suitable.

### Solutions to Problems

An imaging assistance control apparatus according to the present technology includes a control unit that performs control such that guidance regarding a composition change operation by a user is performed by tactile presentation to the user on the basis of a difference between a target composition and an actual composition.

Therefore, it is possible to appropriately guide the composition change operation by the tactile presentation even in a case where guidance by a display is not suitable in a situation in which the user is not able to or is difficult to view a screen or even in a case where guidance by sound is not suitable.

In the imaging assistance control apparatus according to the present technology described above, it is conceivable to have a configuration in which the control unit changes a mode of tactile presentation for the guidance on the basis of a magnitude of a difference between a target composition and an actual composition.

Therefore, it is possible to cause the user to grasp whether the difference between the target composition and the actual composition becomes small or large depending on a difference in the mode of the tactile presentation for the guidance.

In the imaging assistance control apparatus according to the present technology described above, it is conceivable to have a configuration in which the target composition is set as a composition which satisfies a condition that a target subject is arranged at a position set depending on an operation of the user in an image frame, an operation related to setting of an arrangement position of the target subject in the image frame is performed as a drawing operation on a screen displaying a through image of a captured image, and the control unit determines a setting condition excluding the arrangement position among setting conditions of the target composition in accordance with which of a plurality of operation classifications the drawing operation belongs to.

The operation classifications of the drawing operation are obtained by classifying operation modes that can be performed as the drawing operation, and examples thereof can include classifications of an operation of drawing a dot, an operation of drawing a circle, an operation of drawing an ellipse, and the like.

Furthermore, the setting condition of the target composition means a condition for determining the composition of the target composition, and examples thereof include an arrangement position of the target subject in the image frame and a condition for setting a single target subject or multiple target subjects.

According to the configuration described above, the user can designate the arrangement position of the target subject and designate the setting condition excluding the arrangement position among the setting conditions of the target composition by one operation as the drawing operation on the screen.

In the imaging assistance control apparatus according to the present technology described above, it is conceivable to have a configuration in which the target composition is set as a composition which satisfies a condition that a target subject is arranged at a position set depending on an operation of the user in an image frame, and the control unit receives designation of the target subject by voice input from the user.

Therefore, there is no need for the user to operate an operator, such as a button or a touch panel, in the designation of the target subject.

In the imaging assistance control apparatus according to the present technology described above, it is conceivable to have a configuration in which the control unit receives a drawing operation on a screen displaying a through image of a captured image, and determines a situation of a camera obtaining the captured image and sets a composition satisfying a composition condition as the target composition in a case where the situation is a specific situation and a specific mark has been drawn by the drawing operation, the composition condition being associated with the situation and the drawn mark.

Therefore, in a situation in which the camera is in a specific situation, for example, in a theme park such as an amusement park, as a specific mark, for example, the mark imitating a famous character in the theme park, is drawn, it is possible to set, as the target composition, a composition which satisfies a composition condition associated with the situation and the mark, such as a composition in which a character is arranged at a position in the image frame corresponding to the drawn mark.

In the imaging assistance control apparatus according to the present technology described above, it is conceivable to have a configuration in which the target composition is set as a composition which satisfies a condition that a target subject is arranged at a position set depending on an operation of the user in an image frame, an operation of designating an arrangement range of the target subject in the image frame is performed as a drawing operation on a screen displaying a through image of a captured image, and the control unit determines a number of the target subjects to be arranged within the arrangement range in accordance with which of a plurality of operation classifications the drawing operation belongs to.

Therefore, the user can designate the arrangement range of the target subject and designate the number of target subjects to be arranged within the arrangement range by one operation as the drawing operation on the screen.

In the imaging assistance control apparatus according to the present technology described above, it is conceivable to have a configuration in which the target composition is set as a composition which satisfies a condition that a target subject is arranged at a target position in an image frame, and the control unit detects a movement of the target subject and controls guidance to arrange the target subject at the target position on the basis of the detected movement of the target subject.

Therefore, it is possible to perform the guidance in consideration of the movement of the target subject as the guidance for achieving the composition in which the target subject is arranged at the target position in the image frame.

In the imaging assistance control apparatus according to the present technology described above, it is conceivable to have a configuration in which the control unit performs the guidance on the basis of a relationship between the target position and a predicted position of the target subject after a lapse of a predetermined time.

In a case where the movement of the target subject is large, if the guidance based on a difference between a current position of the target subject and the target position is performed, it is difficult to follow the movement of the target subject, and there may occur a situation in which the position of the target subject is hardly adjustable to match the target position. Therefore, the guidance is performed on the basis of the position after the lapse of the predetermined time predicted from the movement of the target subject as described above.

In the imaging assistance control apparatus according to the present technology described above, it is conceivable to have a configuration in which the control unit sets the target composition on the basis of a determination result of a scene to be imaged.

Therefore, it is possible to automatically set the target composition depending on the scene to be imaged, such as a scene of imaging a train at a station or a scene of imaging sunset, on the basis of the scene determination result.

In the imaging assistance control apparatus according to the present technology described above, it is conceivable to have a configuration in which the target composition is set as a composition which satisfies a condition that a target subject is arranged at a target position in an image frame, and the control unit predicts a position at which the target subject is in a target state depending on the scene to be imaged, and controls the guidance such that the predicted position matches the target position.

The target state depending on the scene to be imaged means, for example, a target state of the target subject determined according to the scene, specifically, a state that serves as, for example, a shutter change, such as a state in which a train stops in a scene in which the train is imaged at a station, or a state in which the sun sets in a sunsetting scene.

According to the above configuration, it is possible to appropriately assist the user such that the target subject in the target state is imaged with the target composition.

In the imaging assistance control apparatus according to the present technology described above, it is conceivable to have a configuration in which the control unit enables a function of the guidance in a case where the situation in which the user is not viewing the screen displaying the through image of the captured image is estimated.

Therefore, the guidance according to the present technology is automatically performed in a situation in which the user performs imaging without viewing the screen.

In the imaging assistance control apparatus according to the present technology described above, it is conceivable to have a configuration in which the target composition is set as a composition which satisfies a condition that a target subject is arranged in a target size at a target position in an image frame, and the control unit performs zoom control such that a size of the target subject becomes the target size.

Therefore, it is possible to eliminate the need for a zooming operation by the user in implementation of imaging with the target composition.

In the imaging assistance control apparatus according to the present technology described above, it is conceivable to have a configuration in which the control unit determines whether or not it is a situation in which the user is movable in a case of determining that the size of the target subject is not adjustable to the target size by the zoom control, and causes the guidance for changing a positional relationship between the user and the target subject to be performed in a case of determining that it is the situation in which the user is movable.

Therefore, it is possible to prevent occurrence of an inconvenience such as causing the user to trouble surrounding people by performing the guidance even in a situation in which the user is not movable due to imaging in a crowd or the like, for example.

An imaging assistance control method according to the present technology is an imaging assistance control method including controlling, by an information processing apparatus, such that guidance regarding a composition change operation by a user is performed by tactile presentation to the user on the basis of a difference between a target composition and an actual composition.

With such an imaging assistance control method, it is also possible to obtain functions similar to those of the imaging assistance control apparatus according to the present technology described above.

Furthermore, an imaging assistance system according to the present technology includes: a tactile presentation apparatus including a tactile presentation unit that performs tactile presentation to a user; and an imaging assistance control apparatus including a control unit that performs control such that guidance regarding a composition change operation by the user is performed by tactile presentation of the tactile presentation unit on the basis of a difference between a target composition and an actual composition.

With such an imaging assistance system, it is also possible to obtain functions similar to those of the imaging assistance control apparatus according to the present technology described above.

### BRIEF DESCRIPTION OF DRAWINGS

FIG. 1 is a block diagram illustrating an internal configuration example of an information processing apparatus as an embodiment of an imaging assistance control apparatus according to the present technology.

FIG. 2 is a diagram for describing a specific example of an imaging assistance technique as an embodiment.

FIG. 3 is a flowchart illustrating an example of a specific processing procedure for implementing the imaging assistance technique described in FIG. 2.

FIG. 4 is an explanatory diagram of processing according to a classification of a drawing operation.

FIG. 5 is an explanatory diagram of an example of displaying name information of a type of a subject on a screen.

FIG. 6 is an explanatory diagram of an example of setting a subject within a range drawn on the screen as a target subject.

FIG. 7 is an explanatory diagram for an example of setting a target composition in a case where a specific mark is drawn in a specific situation.

FIG. 8 is a diagram illustrating an example of subject specifying information.

FIG. 9 is a diagram exemplifying a state in a case where multiple target subjects as “dogs” are detected in an image frame.

FIG. 10 is an explanatory diagram of an example of determining the number of target subjects to be arranged within an arrangement range according to an operation classification of a drawing operation for designation of the arrangement range.

FIG. 11 is a diagram illustrating an example of a scene related to guidance of a way of holding a camera.

FIG. 12 is an explanatory diagram of a vertical holding state.

FIG. 13 is a diagram illustrating other examples of the scene related to the guidance of the way of holding the camera.

FIG. 14 is an explanatory diagram of a lateral holding state.

FIG. 15 is an explanatory diagram of an example of guidance based on a movement of a target subject.

FIG. 16 is a diagram illustrating an example of a scene to be imaged.

FIG. 17 is an explanatory diagram of an example of a target composition set according to the scene to be imaged.

FIG. 18 is an explanatory diagram for prediction of a position at which a target subject is in a target state depending on the scene to be imaged.

FIG. 19 is an explanatory diagram for another example of the scene to be imaged.

FIG. 20 is an explanatory diagram for a modified example of vibration presentation for guidance.

FIG. 21 is an explanatory diagram of another modified example of the vibration presentation for guidance.

FIG. 22 is a flowchart illustrating a processing example in a case of performing guidance in consideration of whether or not it is a situation in which a user is movable.

FIG. 23 is a block diagram illustrating a configuration example of an imaging assistance system as an embodiment.

### MODE FOR CARRYING OUT THE INVENTION

Hereinafter, embodiments will be described in the following order.

<1. Configuration of Imaging Assistance Control Apparatus as Embodiment>

<2. Example of Imaging Assistance Technique>

<3. Processing Procedure>

<4. Regarding Technique for Designating Setting Condition of Target Composition>

<5. Regarding Technique for Designating Subject>

<6. Technique for Designating Target Composition Depending on Situation>

<7. Handling in Case where Multiple Target Subjects Exist>

<8. Control According to Movement of Target Subject>

<9. Variations of Tactile Presentation>

<10. Regarding Enabling of Guidance Function>

<11. Error Notification, etc.>

<12. Modified Examples>

<13. Summary of Embodiments>

<14. Present Technology>

### 1. Configuration of Imaging Assistance Control Apparatus as Embodiment

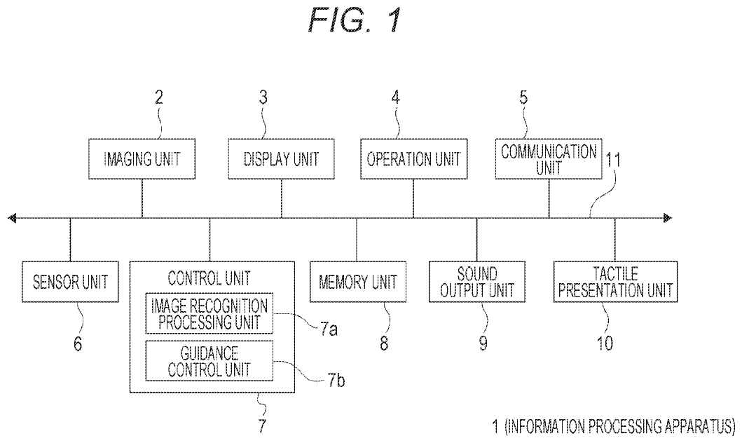

FIG. 1 is a block diagram illustrating an internal configuration example of an information processing apparatus 1 as an embodiment of an imaging assistance control apparatus according to the present technology.

As illustrated in the drawing, the information processing apparatus 1 includes an imaging unit 2, a display unit 3, an operation unit 4, a communication unit 5, a sensor unit 6, a control unit 7, a memory unit 8, a sound output unit 9, and a tactile presentation unit 10, and also includes a bus 11 that connects these units to each other so as to enable data communication.

In the present example, the information processing apparatus 1 is configured as an information processing apparatus having a camera function, for example, a smartphone, a tablet terminal, or the like.

The imaging unit 2 is configured as a camera unit including an imaging optical system and an image sensor such as a charge coupled device (CCD) sensor or a complementary metal oxide semiconductor (CMOS) sensor, and obtains a captured image in digital data.

In the present example, the imaging optical system described above is provided with a zoom lens, and optical zooming can be performed by driving the zoom lens.

Note that the imaging unit 2 can also include both a camera unit as a so-called out-camera that captures an image in a direction opposite to a direction in which a screen 3a of the display unit 3 as described later faces and a camera unit as a so-called in-camera that captures an image in the same direction as the direction in which the screen 3a faces.

The display unit 3 includes a display device capable of displaying an image, for example, a liquid crystal display (LCD), an organic electro luminescence (EL) display, or the like, and displays various types of information on the screen 3a of the display device.

The operation unit 4 comprehensively represents operators, such as a button, a key, and a touch panel, provided in the information processing apparatus 1. In the present example, the touch panel is formed to detect an operation involving contact with the screen 3a.

The communication unit 5 performs wireless or wired data communication with an external apparatus of the information processing apparatus 1. Examples of a data communication scheme with the external apparatus include communication via a communication network, such as a local area network (LAN) or the Internet, and near field wireless communication such as Bluetooth (registered trademark).

The sensor unit 6 comprehensively represents various sensors provided in the information processing apparatus 1. Examples of the sensors in the sensor unit 6 include a microphone, a G sensor (acceleration sensor), a gyro sensor (angular velocity sensor), a temperature sensor, a position sensor that detects a position of the information processing apparatus 1, a proximity sensor, an illuminance sensor, and the like.

Here, examples of the position sensor include a global navigation satellite system (GNSS) sensor, a geomagnetic sensor for geomagnetic positioning, and the like.

Note that Wi-Fi positioning using radio field intensity of Wi-Fi (Wireless Fidelity: registered trademark) can also be performed for the position detection of the information processing apparatus 1.

The control unit 7 includes, for example, a microcomputer including a central processing unit (CPU), a read only memory (ROM), and a random access memory (RAM), and performs control to implement various types of computation and various operations of the information processing apparatus 1 as the above-described CPU executes processing according to a program stored in the above-described ROM or the like, for example.

For example, the control unit 7 performs various types of control on the imaging unit 2. As examples, for example, instructions to start and end an imaging operation, control of the above-described optical zooming, control of electronic zooming, and the like are performed.

Furthermore, the control unit 7 controls output information for information output units serving as the display unit 3, the sound output unit 9, and the tactile presentation unit 10. For example, as an example of control with respect to the display unit 3, control is performed to cause the display unit 3 to display an image captured by the imaging unit 2 as a through image in response to establishment of a predetermined condition, such as activation of a camera application. Furthermore, display control of an image related to a graphical user interface (GUI) is performed in response to an operation input or the like via the operation unit 4.

Furthermore, the control unit 7 has a function as an image recognition processing unit 7a and a function as a guidance control unit 7b as illustrated in the drawing.

The image recognition processing unit 7a performs an image recognition process on an image captured by the imaging unit 2. Specifically, the image recognition processing unit 7a performs, as the image recognition process, a subject detection process of detecting an image region having a specific image characteristic as a subject, such as face detection or pupil detection, a subject recognition process of recognizing a type (for example, types such as a person, a dog, a cat, a bird, a table, a flower, a bicycle, an automobile, a ship, and a mountain) of the detected subject, and a tracking process of tracking a position of the detected subject.

The control unit 7 performs a process of causing the display unit 3 to display information indicating a result of the image recognition process during the display of the through image. For example, the display unit 3 is caused to display information (for example, frame information) indicating a range of the subject detected in the subject detection process described above. Furthermore, the display unit 3 can also be caused to display information indicating the type of the subject recognized in the subject recognition process.

The guidance control unit 7b performs control such that guidance regarding a composition change operation by a user is performed on an image captured by the imaging unit 2 on the basis of a difference between a target composition and an actual composition.

Note that specific processing performed by the control unit 7 as the guidance control unit 7b will be described again.

The memory unit 8 is configured using, for example, a semiconductor storage apparatus such as a flash memory or a nonvolatile storage apparatus such as a hard disk drive (HDD), and stores various types of data used for processing by the control unit 7. In the present example, the memory unit 8 is used as a memory that stores an image captured by the imaging unit 2. For example, at the time of still image capturing, the control unit 7 causes the memory unit 8 to store one frame image captured at a timing instructed by a shutter operation by the user. Furthermore, at the time of moving image capturing, the memory unit 8 is caused to store image data of a moving image obtained by the imaging unit 2 in response to the recording start operation.

The sound output unit 9 includes a speaker and outputs various sounds in response to instructions from the control unit 7.

The tactile presentation unit 10 includes a tactile presentation device that performs tactile presentation to the user. In the present example, the tactile presentation unit 10 includes a vibration device as the tactile presentation device, and can perform tactile presentation to the user by vibrations.

### 2. Example of Imaging Assistance Technique

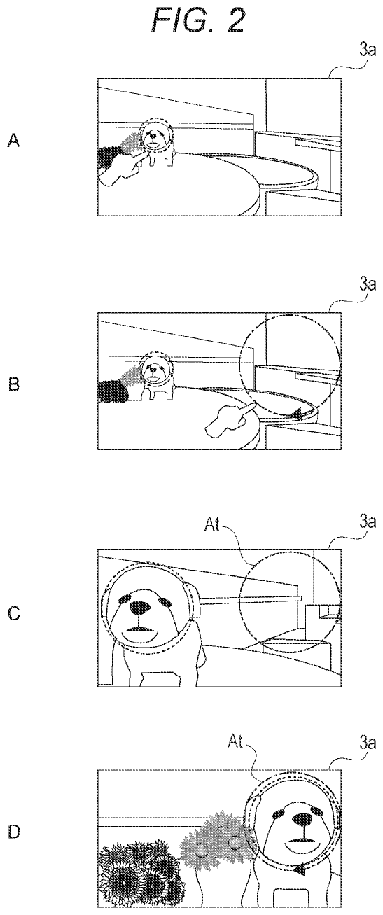

A specific example of an imaging assistance technique as an embodiment will be described with reference to FIG. 2.

In the present embodiment, the guidance regarding the composition change operation by the user is performed on the basis of the difference between the target composition and the actual composition by the tactile presentation (vibrations in the present example) of the tactile presentation unit 10.

Here, note for the sake of clarification that the composition change operation means an operation for changing a composition, such as changing an orientation of the camera, changing a positional relationship between the camera and the subject, or zooming.

In the present example, the target composition is a composition that satisfies a condition that a target subject is arranged in a target size at a target position in an image frame. In the present example, the target composition is set on the basis of an operation input of the user.

Furthermore, it is assumed that the target subject is designated by the user in the present example.

FIG. 2A is a diagram for describing an example of a technique for designating a target subject.

In a case where a subject is detected by the above-described image recognition processing unit 7a on the screen 3a on which a through image of a captured image is displayed, a mark indicating a range of the detected subject, such as a broken-line mark in the drawing, is displayed.

The guidance control unit 7b in the control unit 7 receives an operation (for example, a touch operation) of designating the mark indicating the range of the detection subject displayed in this manner as an operation of designating the target subject.

FIGS. 2B and 2C are diagrams for describing an example of an operation of designating a target area At as an area in which a target subject is to be accommodated.

In the present example, the operation of designating the target area At is an operation of drawing a circle on the screen 3a as illustrated in FIG. 2B. The guidance control unit 7b sets a range designated by such a drawing operation as the target area At (see FIG. 2C).

In the present example, a center position of the target area At is set as a target position Pt, and a composition that satisfies a condition that a position Ps (for example, center position) of the target subject matches the target position Pt and a size of the target subject becomes a target size based on a size designated as the target area At is set as a target composition.

Hereinafter, it is assumed that the target size of the target subject is the same as the size designated as the target area At as an example for the description.

Note that the condition that the size of the target subject exactly matches the size designated as the target area At is not essential, and it is also possible to set, for example, a range of ±10% of the size designated as the target area At as a target size, and this target size can be set as a condition.

The guidance control unit 7b performs guidance to achieve the target composition in response to the setting of the target area At according to an operation of the user.

Here, regarding adjustment of the size of the target subject, the guidance control unit 7b performs zoom control of the imaging unit 2 to perform the adjustment in the present example. That is, the adjustment of the size of the target subject is automatically performed on the information processing apparatus 1 side in the present example, and thus, guidance related to the size of the target subject is not performed.

During the guidance, the position Ps of the target subject is grasped sequentially (for example, for each frame) by the tracking process performed by the image recognition processing unit 7a, and the guidance control unit 7b recognizes a positional relationship between the target position Pt and the position Ps of the target subject.

During the guidance, the guidance control unit 7b performs guidance regarding a change of an orientation of the information processing apparatus 1 (camera) from the positional relationship sequentially recognized as described above.

In the present example, the guidance at this time is performed by changing a mode of tactile presentation on the basis of a magnitude of the difference between the target composition and the actual composition. Specifically, a vibration mode is changed according to a separation distance between the position Ps of the target subject and the target position Pt. For example, as the separation distance between the position Ps of the target subject and the target position Pt decreases, a vibration cycle is shortened. As a specific example, it is possible to give an example in which a first threshold and a second threshold (where the first threshold>the second threshold>0) are set for the separation distance between the position Ps of the target subject and the target position Pt, the number of vibrations per unit time is set as once in a state in which the separation distance exceeds the first threshold, the number of vibrations per unit time is set as twice in a state in which the separation distance is equal to or less than the first threshold and exceeds the second threshold, the number of vibrations per unit time is set as three times in a state in which the separation distance is equal to or less than the second threshold, and the like.

When the vibration control described above is performed, the user can easily grasp whether a composition is close to or far from the target composition in the course of changing the orientation of the information processing apparatus 1 even in a situation in which imaging is performed without gazing at the screen 3a, and it becomes easy to achieve the target composition.

FIG. 2D illustrates an example of a state of the screen 3a when the target composition is achieved. That is, the position Ps of the target subject matches the target position Pt in the present example.

Note that the condition that the position Ps of the target subject matches the target position Pt is not essential as a condition for achievement of the target composition. For example, it is also possible to set other conditions by setting a fact that the distance between the position Ps of the target subject and the target position Pt becomes equal to or less than a predetermined threshold other than zero as a condition for achievement of the target composition, setting a fact that the number of times of matching per unit time between the position Ps of the target subject and the target position Pt reaches a predetermined number of times as a condition for achievement of the target composition, and the like.

In a case where the target composition has been achieved, the guidance control unit 7b causes the tactile presentation unit 10 to make a notification of such a fact in the present example. The notification in the case where the target composition has been achieved is performed in a mode different from tactile presentation for guidance performed in a state in which the target composition has not been achieved.

The user receives the notification of achievement of the target composition described above and performs the shutter operation. Therefore, it is possible to capture a still image with the target composition.

### 3. Processing Procedure

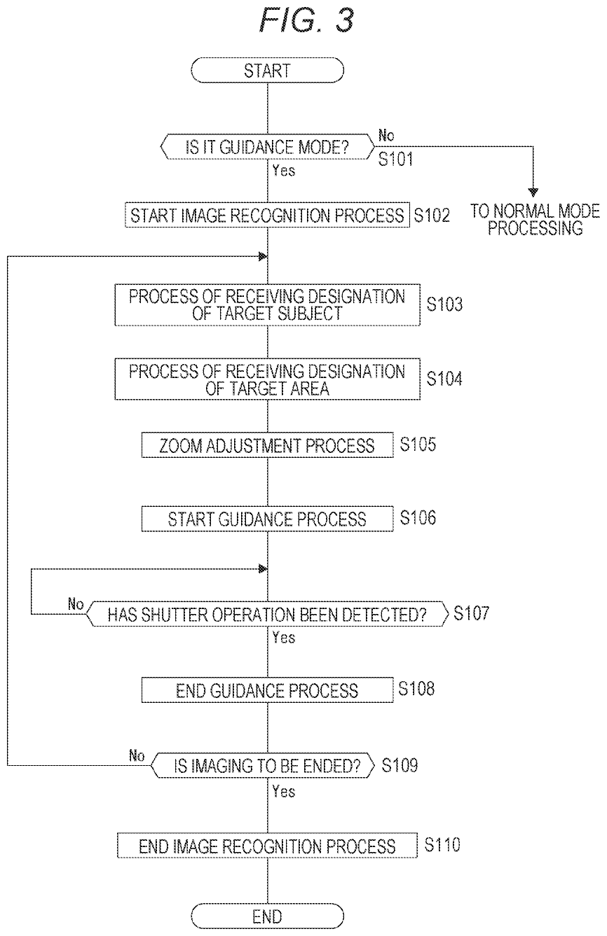

An example of a specific processing procedure for implementing the imaging assistance technique described above will be described with reference to a flowchart of FIG. 3.

Note that the processing illustrated in FIG. 3 is executed by the control unit 7 (CPU) on the basis of a program stored in a predetermined storage apparatus such as the built-in ROM. The control unit 7 starts the processing illustrated in FIG. 3, for example, in response to the activation of the camera application.

First, in step S101, the control unit 7 determines whether or not a mode is a guidance mode. That is, it is determined whether or not the mode is a mode of enabling a function of the guidance regarding the composition change operation described above. If the mode is not the guidance mode, the control unit 7 shifts to normal mode processing. That is, the control unit 7 shifts to processing for imaging without guidance.

On the other hand, if the mode is the guidance mode, the control unit 7 starts the image recognition process in step S102. That is, the processing as the image recognition processing unit 7a described above is started to perform the subject detection process, the subject recognition process, and the subject tracking process.

In step S103 subsequent to step S102, the control unit 7 performs a process of receiving designation of a target subject. That is, an operation of designating a mark indicating a range of a detected subject displayed on the screen 3a in the subject detection process is received.

In a case where an operation of designating a target object subject has been detected, the control unit 7 performs a process of receiving designation of the target area At in step S104. That is, in the present example, the operation of drawing a circle on the screen 3a as exemplified above in FIG. 2B is received. In a case where an operation of designating the target area At has been detected, the control unit 7 sets the target position Pt (at the center position of the target area At in the present example).

In step S105 subsequent to step S104, the control unit 7 executes a zoom adjustment process. That is, zoom control is performed on the imaging unit 2 such that a size of the target subject in a captured image matches a size of the target area At.

In step S106 subsequent to step S105, the control unit 7 starts a guidance process. That is, control is performed such that a composition change operation is guided by vibration presentation of the tactile presentation unit 10 on the basis of a positional relationship between the target position Pt and the position Ps of the target subject sequentially recognized on the basis of the tracking process of the target subject. Specifically, the guidance is performed by changing a vibration mode according to a separation distance between the position Ps of the target subject and the target position Pt in the present example. For example, it is conceivable to perform control to shorten a vibration cycle as the separation distance between the position Ps of the target subject and the target position Pt decreases as exemplified above.

Furthermore, in the guidance process in this case, it is determined whether or not the target composition has been achieved depending on whether or not the position Ps of the target subject matches the target position Pt, and, in a case where the target composition has been achieved, a notification of such a fact is made by vibration presentation of the tactile presentation unit 10.

In step S107 subsequent to step S106, the control unit 7 stands by until detecting the shutter operation, and ends the guidance process in step S108 and advances the processing to step S109 in a case of detecting the shutter operation.

In step S109, the control unit 7 determines whether or not to end the imaging. That is, it is determined whether or not a predetermined condition set in advance as an imaging end condition has been satisfied, for example, detection of an operation of ending the camera application.

For example, in a case where the operation of ending the camera application has not been detected and it is determined not to end the imaging, the control unit 7 returns to step S103. Therefore, the reception of designation of the target subject and the target area At, and the zoom adjustment process and guidance process based on the designated target subject and target area At are performed for the next still image capturing.

On the other hand, in a case where it is determined in step S109 to end the imaging, the control unit 7 ends the image recognition process in step S110, and ends the series of processing illustrated in FIG. 3.

Note that the example in which the guidance is performed at the time of still image capturing has been described above, but the guidance function as the embodiment can also be suitably applied at the time of moving image capturing. In particular, it is not desirable to record unnecessary sound at the time of moving image capturing, and thus, it is suitable to perform the guidance by the tactile presentation as in the embodiment.

Furthermore, the zoom adjustment is performed in the example described above, and thus, guidance regarding a composition change operation for size matching between the target subject and the target area At is not performed in the example, but it is of course possible to perform similar guidance even for the composition change operation for such size matching. For example, it is conceivable to perform guidance for changing a vibration mode of on the basis of a magnitude of a size difference between the target subject and the target area At.

Here, in a case where guidance is performed for both the position matching and size matching between the target subject and the target area At, it is conceivable to perform vibrations for such guides in a time division manner. For example, it is conceivable to assign the first half period in a unit period to the guide for position matching and assign the second half period to the guide for size matching.

Alternatively, it is also possible to provide both the guides by a technique other than time division, such as expressing the guide for position matching and the guide for size matching by a vibration intensity and the number of vibrations per unit time, respectively.

Furthermore, regarding the guide for position matching, it is also possible to guide any direction to which the orientation of the camera is preferably changed. At this time, the direction may be guided in four directions of up, down, right, and left directions, or may be guided only in two directions of vertical and horizontal directions.

### 4. Regarding Technique for Designating Setting Condition of Target Composition

Here, the example in which the operation of designating the target area At, that is, the operation related to a setting of an arrangement position of the target subject in the image frame is the operation of drawing a circle on the screen 3a has been described above, but it is also possible to set classifications of drawing operations on the screen 3a and determine a setting condition excluding the arrangement position of the target subject among setting conditions of a target composition according to such a classification of the drawing operation.

Here, the setting condition of the target composition means a condition for setting any composition that is used as the target composition, and examples thereof can include an arrangement position of the target subject in the image frame and a condition for setting a single target subject or multiple target subjects.

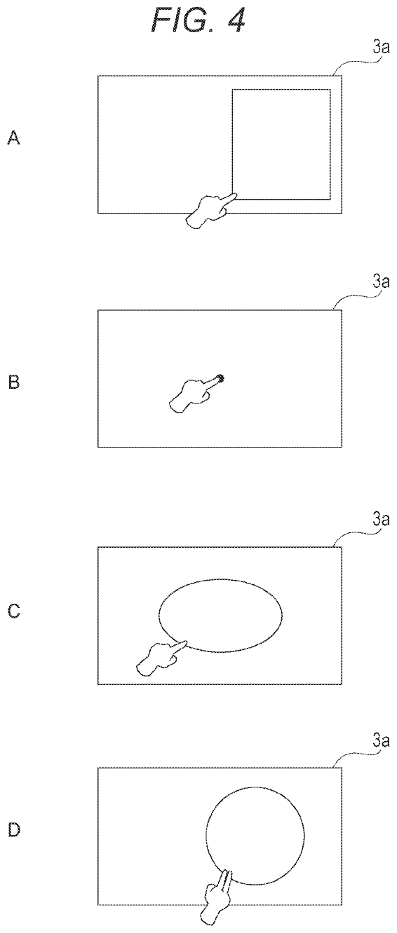

Examples of the classifications of drawing operations include drawing of a quadrangle, drawing of a dot, drawing of an ellipse, and drawing of a circle by a multi-touch through a two-finger touch or the like as illustrated in FIGS. 4A to 4D.

A setting condition excluding the arrangement position of the target subject among the setting conditions of the target composition is set in advance for each classification of such a drawing operation. Then, the guidance control unit 7b determines a setting condition (excluding the setting condition of the arrangement position of the target subject) of the target composition corresponding to such a classification according to any of a plurality of preset classifications to which the classification of the drawing operation a classification of a drawing operation performed by the user belongs.

As a specific example, in a case where a rectangle is drawn as illustrated in FIG. 4A, a condition that the entire body of a subject is put in the rectangle is determined as a setting condition of a target composition.

Furthermore, in a case where a point is drawn as illustrated in FIG. 4B, a condition that a target subject is arranged at a target position Pt with a position of the point as the target position Pt is determined as a setting condition of a target composition without using a size of the target subject as a condition.

Moreover, in a case where an ellipse is drawn as illustrated in FIG. 4C, a condition that multiple target subjects are arranged in the ellipse is determined as a setting condition of a target composition.

Furthermore, in a case where a circle is drawn by multi-tap as illustrated in FIG. 4D, a condition that a target subject is arranged in the circle is determined as a setting condition of a target composition without using a size of the target subject as a condition.

Note that the example described above with reference to FIG. 2 can be said to be an example in which, in a case where a circle is drawn, a condition that a size of a target subject is adjusted to match a size of the circle and the target subject is arranged at the target position Pt set depending on a drawing region of the circle is determined as a setting condition of a target composition.

Since the setting condition of the target composition is determined according to the classification of the drawing operation as described above, the user can designate the arrangement position of the target subject and designate the setting condition excluding the arrangement position among the setting conditions of the target composition by one operation as the drawing operation on the screen 3a.

Therefore, it is possible to reduce burden on the operation of the user.

### 5. Regarding Technique for Designating Subject

Regarding the reception of designation of a target subject, reception by voice can also be performed. For example, the control unit 7 is configured such that a type name of a subject recognizable by the above-described subject recognition process can be identified by voice, and a subject belonging to a type is determined as a target subject in response to recognition of pronunciation of the type name of the subject recognizable in the subject recognition process.

Here, such a process of determining a target subject based on input voice can also be performed at a stage where a subject has not been detected yet in a captured image. For example, in a case where a dog, a child, or the like is desired to be set as a target subject, the user can sense the presence of the dog or the child nearby from surrounding sound or the like, and thus, it is effective to receive designation of a target subject by voice regardless of whether or not the target subject is detected in an image (image frame), In a case where an undetected target subject is designated, as a corresponding type of subject in the image is detected, the subject is set as the target subject.

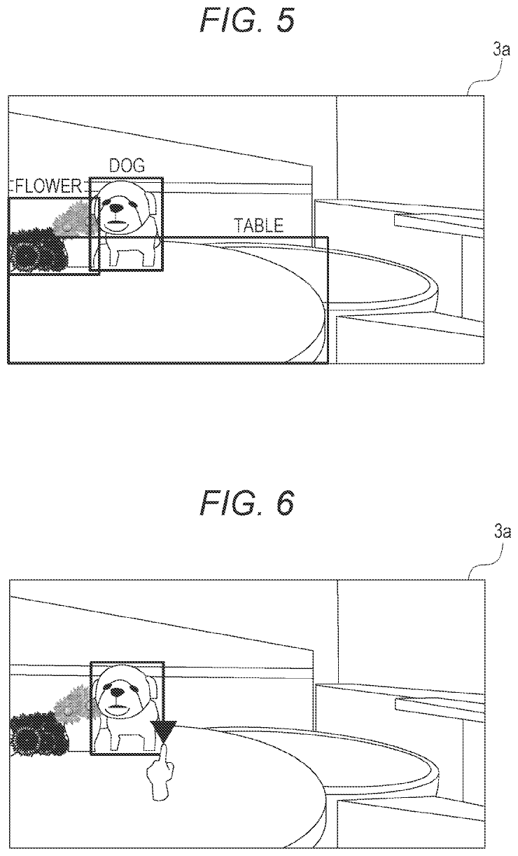

Furthermore, the reception of designation of a target subject can also be performed by displaying name information of a type of a candidate subject and a mark indicating a range thereof, for example, as exemplified in FIG. 5. In this case, the guidance control unit 7b displays, on the screen 3a, a mark indicating a range of a subject whose type has been recognized among detected subjects, and name information of the type.

Furthermore, the reception of designation of a target subject can be performed as reception of a range drawing operation on the screen 3a as exemplified in FIG. 6. In this case, a subject in the drawn range is set as the target subject.

Such a reception technique is a technique that is suitable in a case where an object that the user desires to set as the target subject has not been detected by the subject detection process.

Note that the technique illustrated in FIG. 6 may be inferior in robustness of tracking, but improvement can be expected by using a background difference or an optical flow technique.

Furthermore, in the case where the designation of a target subject is performed by the range drawing operation as illustrated in FIG. 6, it is conceivable to make a notification to allow the user to identify whether the designation of the target area At is received or the designation of the target subject is received.

Furthermore, as the reception of designation of a target subject, it is also possible to display a list of pieces of information indicating subject types that can be recognized in the subject recognition process on the screen 3a to receive designation from the list.

Furthermore, in a case where a target subject becomes untrackable after the target subject has been designated, an error notification may be made. This notification is made by vibration presentation of the tactile presentation unit 10, for example.

### 6. Technique for Designating Target Composition Depending on Situation

The setting of a target composition according to an operation of the user is not limited to the specific examples exemplified above. For example, a situation of the information processing apparatus 1 functioning as the camera can be determined, and, in a case where the situation is a specific situation and a specific mark is drawn by a drawing operation on the screen 3a, a composition satisfying a composition condition associated with the situation and the drawn mark can be set as a target composition.

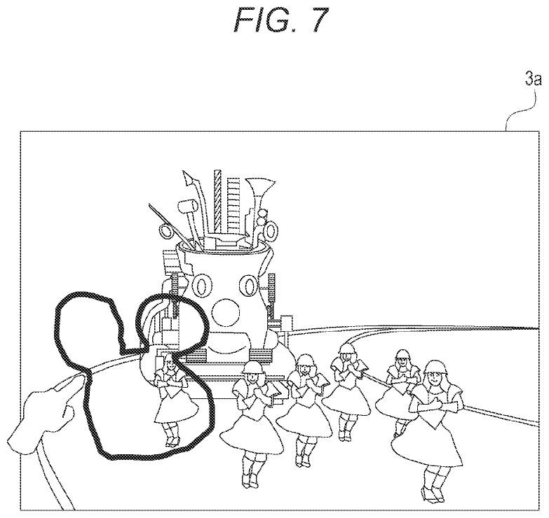

A specific example will be described with reference to FIG. 7.

The example of FIG. 7 is an example in which, in a case where a mark imitating a specific character in a specific theme park is drawn on the screen 3a in a situation in which the information processing apparatus 1 is located in the specific theme park, a composition in which the character is arranged at a position in an image frame corresponding to the drawn mark is set as a target composition.

Furthermore, in a case where a star mark is drawn on the screen 3a in a situation in which the information processing apparatus 1 is facing the sky outdoors although not illustrated, an example of setting a composition in which the brightest star is arranged within a range of the star mark as a target composition is also conceivable.

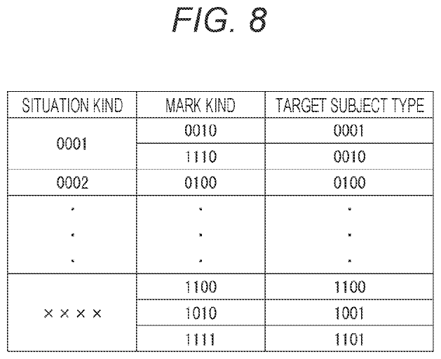

In a case where a target composition is set according to a situation and a drawing mark as described above, subject specifying information I1 as exemplified in FIG. 8 is stored in a storage apparatus that can be read by the control unit 7 such as the memory unit 8.

The guidance control unit 7b determines whether or not a situation of the information processing apparatus 1 is a predetermined specific situation. For example, in the example of FIG. 7, it is determined whether or not the information processing apparatus 1 is located in the specific theme park. This determination can be made, for example, on the basis of a detection signal of the position sensor in the sensor unit 6. Furthermore, in the example of the star described above, it is determined whether or not the information processing apparatus 1 is facing the sky outdoors. This determination can be made on the basis of, for example, detection signals of the position sensor and the microphone in the sensor unit 6 and detection signals of the G sensor and the gyro sensor.

The guidance control unit 7b recognizes a kind of the situation in which the information processing apparatus 1 is placed by performing such a determination.

Furthermore, in a case where a drawing operation is performed on the screen 3a, the guidance control unit 7b determines whether or not a drawn mark is a specific mark. For example, whether or not the mark is the mark imitating the specific character is determined in the example of FIG. 7, and whether or not the mark is the star mark is determined in the example of the star described above. The guidance control unit 7b recognizes a kind of the drawn mark by performing such a determination.

In the subject specifying information I1, information indicating a type of a target subject is associated with each combination of a situation kind and a mark kind, and the guidance control unit 7b can obtain information indicating a type of subject to be targeted in a target composition from the subject specifying information I1 by recognizing the situation kind and the mark kind as described above.

The guidance control unit 7b sets the subject, specified from the information on the subject type obtained with reference to the information processing apparatus 1 in this manner, as the target subject, and sets a composition which satisfies a condition that the target subject is arranged within a range of the mark drawn on the screen 3a as the target composition.

### 7. Handling in Case where Multiple Target Subjects Exist

In a case where multiple subjects corresponding to a type designated as a target subject exist in an image frame, it is also possible to receive designation of a range in which the target subject is desired to be arranged and how many target subjects are to be arranged within the range.

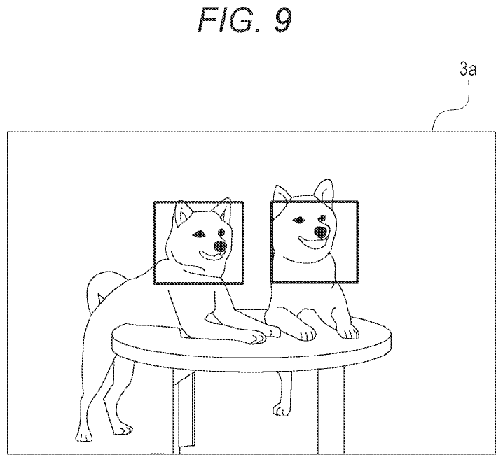

FIG. 9 exemplifies a state in a case where multiple target subjects as “dogs” are detected in an image frame of a captured image.

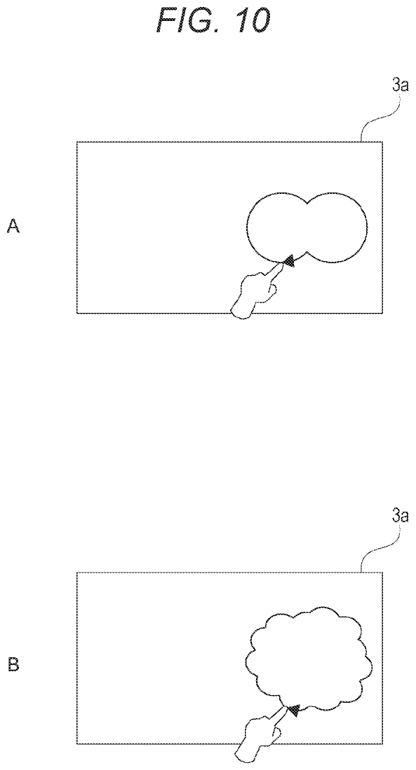

For example, in a case where a drawing operation for designating a range is performed so as to have two bulging portions on the screen 3a as illustrated in FIG. 10A, a composition in which two target subjects among the multiple detected target subjects are arranged within the designated range is set as a target composition.

Furthermore, in a case where a drawing operation for designating a range is performed so as to have a predetermined number or more (for example, at least three or more) of bulging portions as in FIG. 10B, a composition in which all of the multiple detected target subjects are arranged within the designated range is set as a target composition.

For example, as in the above example, in a case where an operation of designating an arrangement range of a target subject is performed as a drawing operation on the screen 3a, the guidance control unit 7b can determine the number of target subjects to be arranged within the arrangement range according to which of a plurality of operation classifications the drawing operation belongs to.

As the number of target subjects to be arranged within the arrangement range is determined on the basis of the operation classification of the drawing operation for designating the arrangement range in this manner, the user can designate the arrangement range of the target subject and designate the number of target subjects to be arranged within the arrangement range by one operation as the drawing operation on the screen 3a.

Therefore, it is possible to reduce burden on the operation of the user.

Note that the user can estimate whether or not multiple objects as target subjects exists in the surroundings from a surrounding situation (vision, sound, or the like). For example, it is possible to estimate the existence of multiple objects from barking sound in the case of dogs or sound or the like in the case of children. From this point, the reception of designation of an arrangement range of a target subject and the determination of an arrangement number of target subjects according to a classification of a drawing operation for designation of the arrangement range can also be performed in a state in which no target subject has been detected in a captured image.

Furthermore, in a case where multiple subjects corresponding to a type designated as a target subject are detected in an image, the user can also be notified of such a fact. For example, it is conceivable to make a notification by voice such as “there are two dogs”.

Furthermore, regarding tracking of a target subject during execution of guidance to arrange multiple target subjects in a specified arrangement range, only a target subject close to the arrangement range may be tracked in a case where some target subjects are separated from the other target subjects.

Furthermore, regarding tracking of a target subject during execution of guidance to arrange multiple target subjects in a specified arrangement range, in a case where some target subjects among the multiple target subjects are lost, the remaining target subjects are tracked to continue the guidance.

Furthermore, which subject among multiple target subjects is to be set as a tracking target for guidance may be dynamically determined on the basis of a size of an arrangement range designated by the user. For example, in a case where there are two target subjects, it is conceivable to set one target subject as a tracking target for guidance if an image size of a specified arrangement range is equal to or smaller than a predetermined size, such as 100 pixels×100 pixels, or, if not, set the two target subjects as tracking targets for guidance.

Note that, in a case where “single” is designated as designation as to how many target subjects to be accommodated within a designated arrangement range, it is conceivable to set a subject closest to the arrangement range among multiple target subjects detected in an image as a tracking target for guidance.

Alternatively, in a case where multiple target subjects have been detected for the designation of “single” as described above, it is also possible to present characteristics (for example, hair colors, sizes, and the like in the case of dogs) of the multiple target subjects to the user and ask the user about which should be set as a target.

### 8. Control According to Movement of Target Subject

Various types of control are conceivable as control according to movements of a target subject.

For example, it is conceivable to estimate a moving direction of the target subject from image analysis of a captured image and guide a way of holding the information processing apparatus 1 (camera) according to the direction.

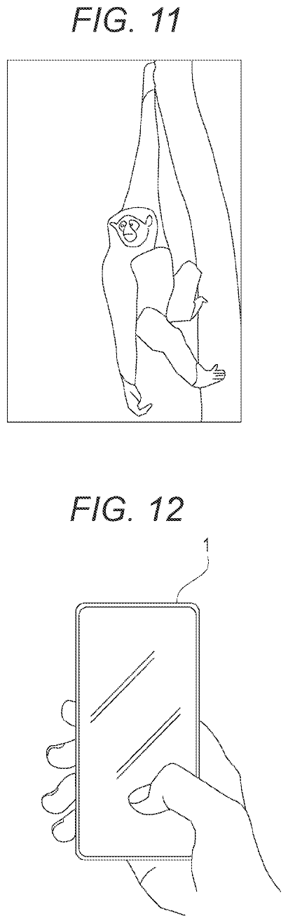

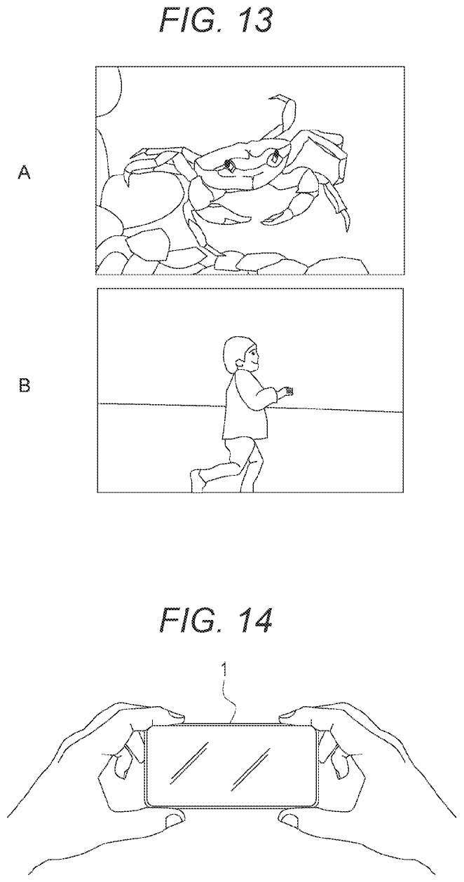

Specifically, for example, in a scene where a monkey climbs a tree as illustrated in FIG. 11, the user is provided with a guide instructing vertical holding as illustrated in FIG. 12. Furthermore, in a scene where a crab moves as illustrated in FIG. 13A or a scene where a child walks as illustrated in FIG. 13B, the user is provided with a guide instructing lateral holding as exemplified in FIG. 14.

At this time, the estimation of the moving direction of the target subject can be estimation from, for example, a direction or an amount of a flow of a background in the captured image, and the like. Alternatively, a technique of preparing a table in which a direction is associated with each type of target subject and obtaining direction information corresponding to the determined type of the target subject from the table is also conceivable.

Furthermore, as a guidance control technique in a case where a target subject is a moving subject, it is also possible to detect a movement of the target subject and perform guidance control to arrange the target subject at the target position Pt on the basis of the detected movement of the target subject.

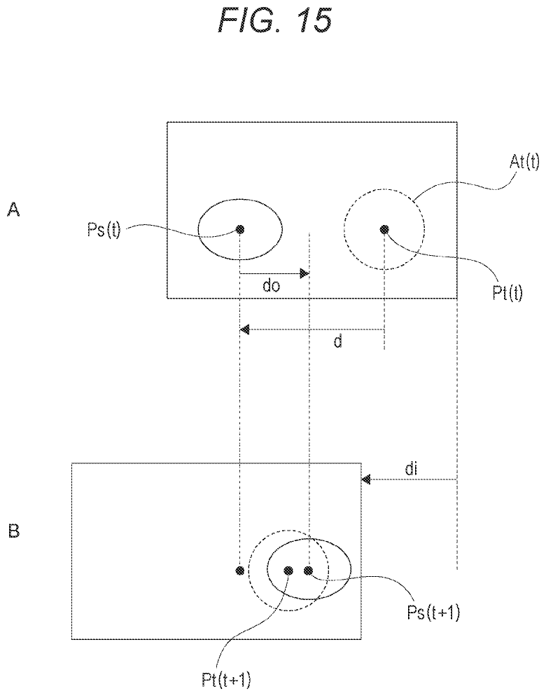

FIG. 15A illustrates a relationship among a position Ps(t) of a target subject, a target area At(t), and a target position Pt(t) at a certain time (t).

As illustrated in the drawing, a separation distance between the position Ps(t) of the target subject and the target position Pt(t) is “d”. Normally, it is conceivable to provide a guide based on the separation distance d as a guide at a time point (t).

However, at a time point (t+1) after a lapse of a predetermined period from the time (t), assuming that a movement amount of the target subject during the predetermined period is “do” as illustrated in the drawing, the target subject also moves by “do” in a case where the user changes an orientation of the camera according to the guide at the time point (t) and moves an image frame side by “di” as illustrated in FIG. 15B, and thus, it is difficult to arrange a position Ps(t+1) of the target subject at a target position Pt(t+1).

Therefore, over a period of a plurality of past frames of a captured image, a movement amount “de” of the target subject between the respective frames is calculated, and guidance based on the movement amount de is performed. Instead of a simple average, constant velocity, acceleration, and deceleration are calculated in a distinguishable manner. The movement amount de is a vector amount having a distance and a direction.

During the guidance, in a case where the target subject moves in a direction of approaching the target position Pt, the guidance control unit 7b sets “d−de” as a target value of a movement amount on the image frame side, and performs control so as to provide a guide that requests the user not to move the camera too much. On the other hand, in a case where the target subject moves in a direction away from the target position Pt, the guidance control unit 7b sets “d+de” as a target value of a movement amount on the image frame side, and performs control such that the user is guided to move the camera more.

In this manner, the guidance in consideration of the movement of the target subject is implemented as the guidance for achieving the composition in which the target subject is arranged at the target position in the image frame.

Therefore, the accuracy of the guidance can be improved in accordance with the case where the target subject is the moving subject.

Furthermore, as the guidance in consideration of a movement of a subject, it is also possible to perform guidance based on a relationship between a predicted position of a target subject after a predetermined time and a target position can be performed.

Specifically, in such a case, the guidance control unit 7b obtains a movement amount of the target subject on the basis of, for example, captured images corresponding to a plurality of past frames, and predicts a position of the target subject after a lapse of a predetermined time from the movement amount. Then, guidance is performed on the basis of a relationship between the position predicted in this manner and the target position Pt. Specifically, for example, it is conceivable to perform guidance to change a vibration mode on the basis of a magnitude of a separation distance between the predicted position and the target position Pt.

It is also possible to improve the accuracy of the guidance in accordance with the case where the target subject is the moving subject by performing such guidance based on the predicted position of the target subject.

Furthermore, in a case where still image capturing is performed with a moving subject as a target subject, the following guidance can also be performed.

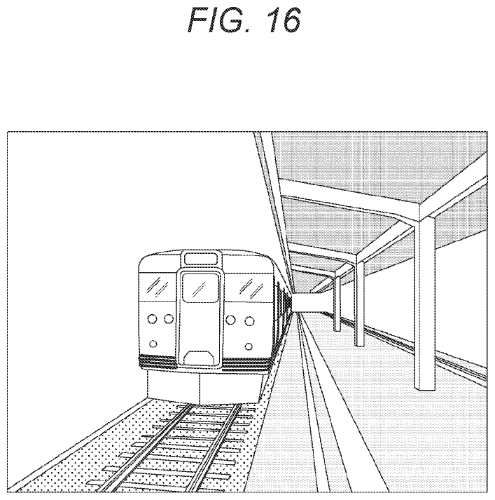

First, a case where a still image of a train is captured at a platform of a station is assumed, for example, as exemplified in FIG. 16.

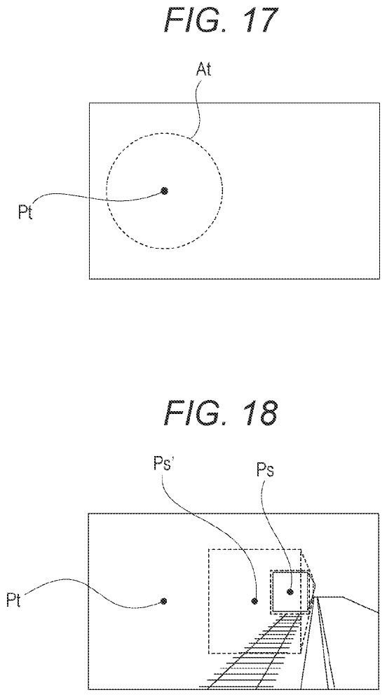

In the present example, it is assumed that the guidance control unit 7b sets a target composition on the basis of a determination result of a scene to be imaged. Here, it is assumed that an optimal composition is set in advance for the scene to be imaged in which the train is present at the platform of the station as illustrated in FIG. 16. Specifically, a target subject is the train and a composition in which the target area At (target position Pt) is set as illustrated in FIG. 17 is set as the target composition.

In the present example, a plurality of combinations of a scene to be imaged and an optimum composition (including information on a type of a subject to be set as the target subject) is set to handle a plurality of scene to be images.

The guidance control unit 7b determines a current scene to be imaged by image analysis processing or the like on an image captured by the imaging unit 2. Here, a technique of determining the scene to be imaged is not particularly limited. For example, a technique using artificial intelligence (AI) trained to sort a scene from an image can be exemplified. Alternatively, it is also conceivable to estimate an environment in which the information processing apparatus 1 is placed on the basis of input information from various sensors such as the microphone, the position sensor, the G sensor, and the gyro sensor, and determine a scene.

Then, the guidance control unit 7b sets the optimum composition determined for the determined scene to be imaged as the target composition.

In response to the setting of the target composition in this manner, the guidance control unit 7b performs processing for guidance.

The guidance in this case is not performed on the basis of a current position of the target subject, but is performed on the basis of a position at which the target subject is in a target state set according to the scene to be imaged.

The target state here means a target state of the target subject set according to the scene to be imaged. Specifically, the target state means, for example, a state serving as a shutter chance.

For the scene to be imaged of the train illustrated in FIG. 16, a state in which the train as the target subject stops is determined as the target state.

In this case, as exemplified in FIG. 18, for example, the guidance control unit 7b predicts a position Ps' at which the subject as the train is in the target state, that is, the stop state, from the current captured image, and controls the tactile presentation unit 10 such that guidance to arrange the predicted position Ps' at the target position Pt is performed.

Here, the position (Ps′) at which the train is in the stop state at the platform of the station can be estimated from a position of a stop line by detecting an image of the stop line of the train at the platform, for example. Alternatively, a speed of the train may be calculated from a captured image, and the position at which the stop state is achieved may be estimated on the basis of the speed. Note that information on a distance to the train is used in such estimation of a stop position based on the speed, but the information on the distance may be calculated using a time difference between captured images or may be obtained separately using a ranging sensor.

Note that a shutter may be automatically turned off (a captured image of a still image may be stored in the memory unit 8) on condition that a target subject is within the target area At.

Furthermore, in the example of the train described above, it is also conceivable to set a size of the target area At to a size based on a size of the train when the train has reached the stop position.

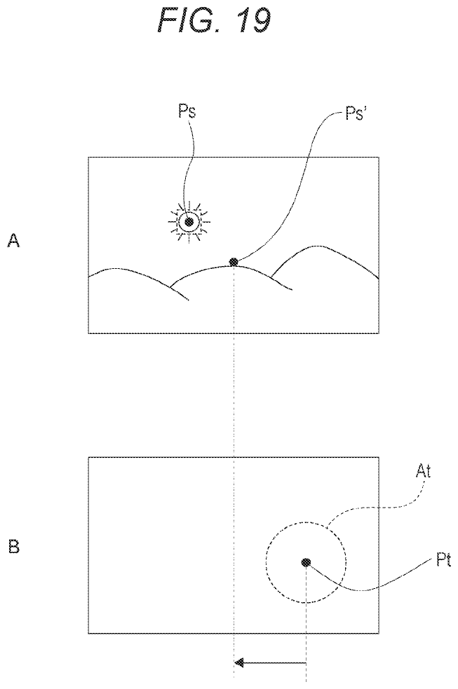

Although the scene related to the train has been exemplified as an example of the scene to be imaged as described above, guidance by a similar technique can be performed for, for example, a sunset scene as exemplified in FIG. 19A.

For the sunset scene to be imaged, a target subject is the sun and a composition in which the target area At (target position Pt) is set as illustrated in FIG. 19B is set as a target composition.

Furthermore, in the sunset scene to be imaged, a state in which the sun sets is determined as a target state of the target subject.

Note that current time information can also be used to determine whether or not a scene is the sunset scene to be imaged.

In this case, the guidance control unit 7b predicts a position Ps' at which the target subject is in the target state, that is, a position at which the sun sets here, from the current captured image as exemplified in FIG. 19A. The position where the sun sets can be predicted, for example, on the basis of a movement trajectory of the sun obtained from captured images within a certain past period.

In response to the prediction of the position (Ps′) at which the sun sets, the guidance control unit 7b in this case controls the tactile presentation unit 10 such that guidance is performed to arrange the predicted position Ps' at the target position Pt.

Here, a target composition for each scene to be imaged can also be set on the basis of a result of analyzing compositions of a large number of captured images uploaded on the Internet, such as captured images posted on social networking service (SNS) sites.

Alternatively, a favorite composition of the user can also be learned and set on the basis of a result of analyzing compositions of past images captured by the user.

### 9. Variations of Tactile Presentation

Here, it is conceivable to change an intensity, a frequency, an interval, or a pattern of vibrations at the time of changing a vibration mode in guidance.

Furthermore, not only the vibration for guidance but also vibrations can also be used to make a notification of another information at the same time. For example, in a case where a separation distance between the position Ps of a target subject and the target position Pt is expressed by vibrations, it is conceivable to make a notification of an intensity of a movement of the subject by vibrations. In this case, it is conceivable to express the separation distance from the target position Pt by a difference in vibration frequency, and to express a movement amount of the subject between frames by the vibration intensity.

Furthermore, in a case where multiple target subjects are to be arranged in the target area At, in a case where a situation has changed, such as a case where some of the target subjects have been lost or a case where a lost target subject has been successfully tracked again, it is also possible to make a notification of such a fact by vibrations.

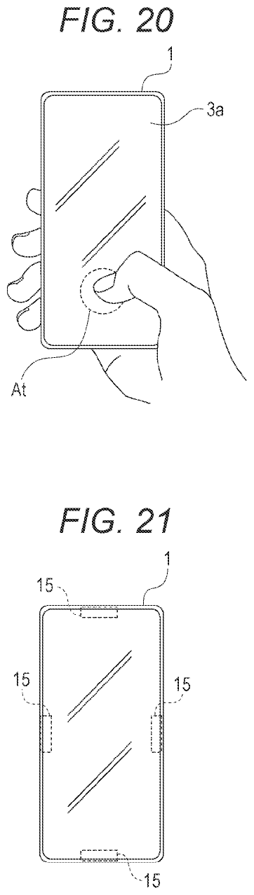

Furthermore, the vibration for guidance can also be performed in a form of a screen vibration as exemplified in FIG. 20. In this case, the guidance is performed by vibrations of the screen after designation of the target position Pt on the premise that a finger is kept touching the screen 3a after the designation of the target position Pt by touching the screen 3a. In this case, for example, it is conceivable to express a separation distance from the target position Pt by the vibration intensity (for example, the vibration becomes stronger as the distance decreases). Note that, for example, a piezoelectric element may be used as a vibration device in this case.

Furthermore, as exemplified in FIG. 21, it is also conceivable to perform guidance by vibrations using vibration devices 15 arranged on upper, lower, right, and left side portions of the information processing apparatus 1. In this case, it is possible to notify the user of any direction in which the information processing apparatus 1 is preferably moved according to any position of the vibration device that is to be vibrated.

In this case, a technique of expressing the closeness to the target position Pt by the vibration intensity can also be applied.

### 10. Regarding Enabling of Guidance Function

The guidance function for the composition change operation can be enabled or disabled on the basis of an operation of the user.

For example, it is conceivable to enable the guidance function in a case where an operation of setting a “visual impairment mode” has been performed in an item of accessibility in a “setting” menu in a smartphone.

Alternatively, it is also conceivable to automatically enable the guidance function.

For example, it is conceivable to enable the guidance function in a case where a situation in which the user is not viewing the screen 3a has been estimated.

Specifically, in a case where imaging is performed in a crowd or the like, there is a case where imaging is performed with a hand raised high, and in such a case, the imaging is performed without viewing the screen 3a. Therefore, estimation of whether or not the user is performing the imaging while raising the hand is performed as estimation of whether or not it is the situation in which the user is not viewing the screen 3a, and the guidance function is enabled in a case where it is estimated that the user is performing the imaging while raising the hand. Here, it is possible to estimate whether or not the user is performing the imaging while raising the hand on the basis of, for example, an image captured by the in-camera and a detection signal from the G sensor or the gyro sensor in the sensor unit 6. Alternatively, the estimation can be performed using a detection signal from a height sensor.

Alternatively, the estimation of whether or not it is the situation in which the user is not viewing the screen 3a can be performed as, for example, estimation of whether or not a line of sight of the user is directed to the screen 3a. Whether or not the line of sight of the user is directed to the screen 3a can be estimated on the basis of, for example, an image captured by the in-camera.

Furthermore, it is also conceivable to enable the guidance function in response to recognition of a specific type of subject from a captured image.

Alternatively, it is also conceivable to enable the guidance function in response to a determination that a movement of a subject is great.

Furthermore, a condition for enabling the guidance function may be an AND condition of these. For example, the guidance function is enabled if a “child” is recognized as a subject and a movement of the subject is great or the like.

### 11. Error Notification, Etc

In a case where a condition that a size of a target subject is adjusted to match a target size is set as a target composition, there may be a case where the size of the target subject is excessively large or excessively small with respect to the target size so that it is not possible to achieve matching with the target size through size adjustment by zooming.

In a case where it is not possible to perform zooming any more, or in a case where it is predicted that the matching with the target size is not possible through the size adjustment by zooming, it is conceivable to notify the user of such a fact by tactile presentation of the tactile presentation unit 10.

As an example, the following description will be given regarding an example in which whether or not it is a situation in which the user is movable is determined in a case where it is determined that it is not possible to adjust a size of a target subject to match a target size by zoom control on the premise that the size matching is automatically performed by the above-described zoom control (see step S105), and an error notification is made in a case where it is determined that it is not the situation in which the user is movable. Here, in a case where it is determined that it is the situation in which the user is movable, guidance is performed to change a positional relationship between the user and the target subject.

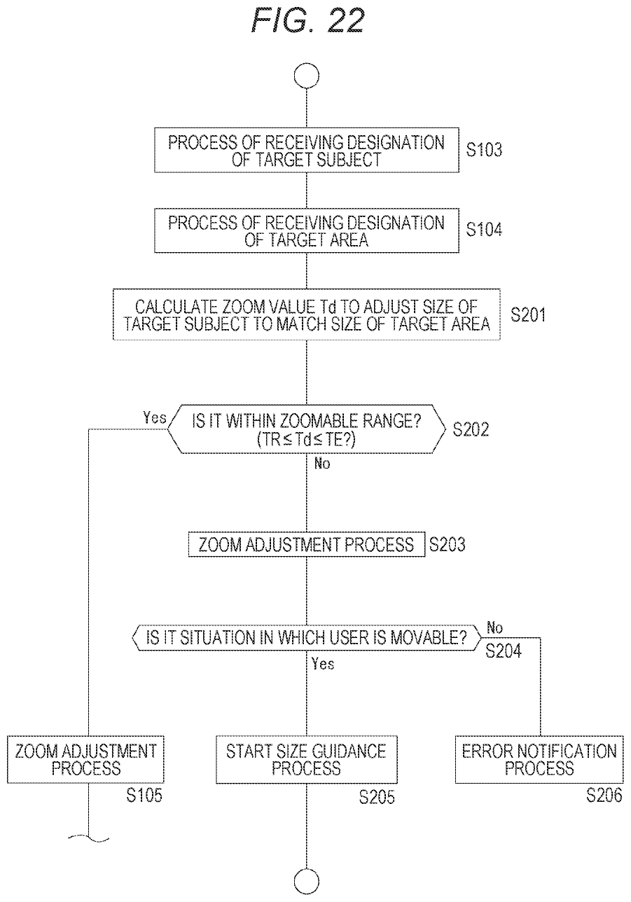

An example of a specific processing procedure will be described with reference to a flowchart of FIG. 22.

Note that some of processes to be executed in step S103 and the subsequent steps in the processing illustrated in FIG. 3 are extracted and illustrated in FIG. 22.

In this case, the control unit 7 calculates a zoom value Td for adjusting a size of a target subject to match a size of the target area At in step S201 in response to the execution of the process of receiving designation of the target subject in step S103 and the process of receiving designation of the target area At in step S104. This zoom value is obtained as a value within a zoomable range (for example, 35 mm to 100 mm).

Then, in step S202 subsequent to step S201, the control unit 7 determines whether or not it is within the zoomable range. Specifically, it is determined whether or not the above-described zoom value Td is within a range that is equal to or larger than a minimum zoom value TR and equal to or smaller than a maximum zoom value TE which will be described below.

The minimum zoom value TR is a minimum value in the zoomable range, and the maximum zoom value TE is a maximum value in the zoomable range.

Here, in a case where it is assumed to use only optical zooming, the maximum zoom value TE is set to the maximum value in the zoomable range by the optical zooming. In a case where digital zooming (cropping of a captured image) is used, it is conceivable to determine the maximum zoom value TE in consideration of image quality degradation caused by the digital zooming. Since conditions for causing a failure in recognition of any object as the image quality becomes coarse by the digital zooming vary depending on brightness, an environment, a subject type, and eyesight of the user, the maximum zoom value TE may be adaptively determined according to these conditions, for example.

In a case where it is determined in step S202 that it is within the zoomable range, the control unit 7 advances the processing to step S105 and executes the zoom adjustment process. In this case, the processes in step S105 and the subsequent steps illustrated in FIG. 3 are executed, and guidance is performed to adjust the position Ps of the target subject to match the target position Pt.

On the other hand, in a case where it is determined in step S202 that it is not within the zoomable range, the control unit 7 performs a zoom adjustment process in step S203. In the zoom adjustment process in this case, a process of performing adjustment to the minimum zoom value TR (in a case where the size is larger than the target size) or the maximum zoom value TE (in a case where the size is smaller than the target size) is performed.

Then, in step S204 subsequent to step S203, the control unit 7 determines whether or not it is a situation in which the user is movable. That is, for example, it is determined whether or not it is a situation in which the user is not movable forward or backward due to imaging in a crowd or the like. Whether or not it is the situation in which the user is movable can be determined on the basis of, for example, analysis of an image captured by the imaging unit 2, detection sound (environmental sound around the information processing apparatus 1) obtained by the microphone in the sensor unit 6, and the like.

In a case where it is determined in step S204 that it is the situation in which the user is movable, the control unit 7 proceeds to step S205 and starts a size guidance process. That is, control is performed such that guidance for adjusting the size of the target subject to match the target size is performed by tactile presentation of the tactile presentation unit 10. The guidance is performed in a form in which the user can recognize whether to move the information processing apparatus 1 forward (in a direction approaching the target subject) or backward at least depending on whether the size of the target subject is smaller or larger than the target size.

Note that the control unit 7 may advance the processing to step S107 illustrated in FIG. 3 after the size guidance process is started in step 3205.

Furthermore, in a case where it is determined in step 3204 that it is not the situation in which the user is movable, the control unit 7 executes an error notification process in step S206. That is, a notification indicating that it is not possible to adjust the size of the target subject to match the target size is made with respect to the user. It is conceivable that this notification is executed by tactile presentation of the tactile presentation unit 10.

Note that a notification prompting the user to change a size of the target area At may be made in the error notification process in step S206.

As illustrated in FIG. 22, the control unit 7 in this case determines whether or not it is the situation in which the user is movable in the case of determining that it is not possible to adjust the size of the target subject to the target size by the zoom control, and causes the guidance for changing a positional relationship between the user and the target subject to be performed in a case of determining that it is the situation in which the user is movable.

Therefore, it is possible to prevent occurrence of an inconvenience such as causing the user to trouble surrounding people by performing the guidance even in a situation in which the user is not movable due to imaging in a crowd or the like, for example.

Note that, as an error notification related to imaging, it is also conceivable to make a notification regarding so-called finger fogging, blurring, or large hand shaking. Note that the finger fogging means a state in which at least a part of fingers of the user holding the camera touches a lens or the like to block at least a part of an imaging field of view.

Whether or not the finger fogging has occurred can be determined from a captured image, for example.

Furthermore, whether or not it is a situation in which the hand shaking is large can be determined from a detection signal obtained by the G sensor or the gyro sensor in the sensor unit 6 or a captured image (for example, a difference between frames). The presence or absence of occurrence of the blurring can be performed as the determination as to whether or not autofocus (AF) has been performed on a designated target subject.

In a case where it is determined that the situation in which the finger fogging, the blurring, and the large hand shaking occurs, the control unit 7 makes a predetermined notification as the error notification by tactile presentation of the tactile presentation unit 10.

Note that it is also conceivable to separately issue a notification regarding the blurring depending on a type of a cause thereof. For example, different error notifications are made between a case that is solved when the user moves a position and a case where it is necessary to designate a target subject again. In this case, action that the user needs to take can be notified by tactile presentation, sound, or the like.

Furthermore, regarding the error notification, it is also possible to make a notification (for example, make a notification by tactile presentation) that a specific object (for example, a dangerous article: a bicycle, an automobile, or the like) has been detected in a captured image during guidance.

### 12. Modified Examples

Note that embodiments are not limited to the specific examples described above, and configurations as various modified examples can be adopted.

For example, it is conceivable to recognize a user type by an in-camera and switch various settings of the information processing apparatus 1. As an example, for example, if the user is an elderly person, it is conceivable to perform a setting to increase the shutter speed in order to prevent the hand shaking.

Alternatively, if the user is an elderly person, it is also conceivable to perform a setting to increase the vibration intensity during guidance.

Furthermore, in a case where the user is recognized to be a person other than Japanese, a user interface (UI) may be changed to the English version.

Furthermore, for example, in a case where there are many people who desire to image the same subject such as the same character in a specific place such as a theme park, it is also conceivable to guide them to optimum positions, respectively, for optimization as a whole.

Furthermore, in the description given so far, the example has been described in which the vibration device for guidance and the camera that obtains a captured image are mounted on an integrated apparatus which is the information processing apparatus 1, but the vibration device for guidance is not limited to being mounted on the integrated apparatus with the camera that obtains a captured image.

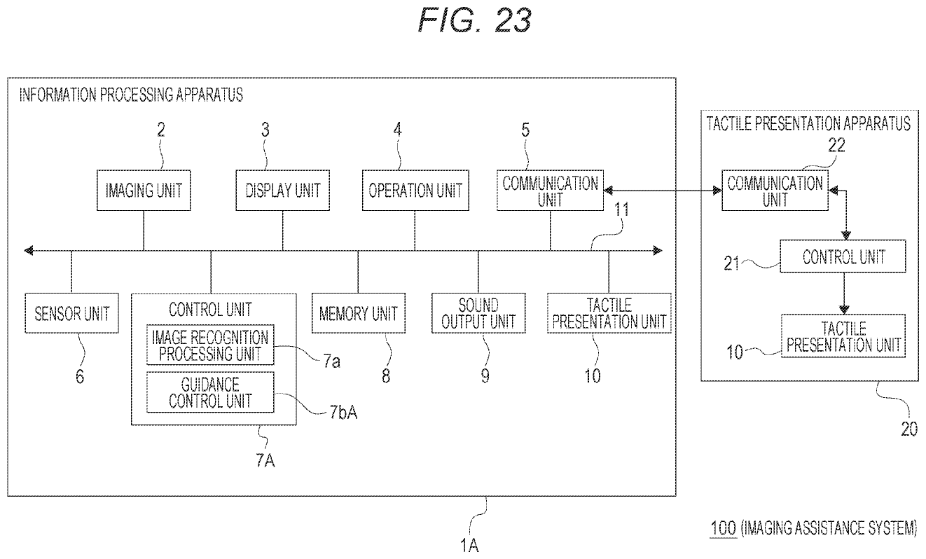

For example, as in an imaging assistance system 100 illustrated in FIG. 23, it is also possible to adopt a configuration in which a tactile presentation apparatus 20 that performs vibration presentation for guidance is a separate body. Note that, in FIG. 23, portions similar to those already described are denoted by the same reference signs, and the description thereof will be omitted.

As illustrated in the drawing, the imaging assistance system 100 includes an information processing apparatus 1A and the tactile presentation apparatus 20. The tactile presentation apparatus 20 includes the tactile presentation unit 10, a control unit 21, and a communication unit 22.

The information processing apparatus 1A is different from the information processing apparatus 1 illustrated in FIG. 1 in that a control unit 7A is provided instead of the control unit 7. Note that, in this case, the communication unit 5 is configured to be capable of performing data communication with the communication unit 22 in the tactile presentation apparatus 20.

The control unit 7A is different from the control unit 7 in that the control unit 7A includes a guidance control unit 7bA instead of the guidance control unit 7b.

The guidance control unit 7bA performs control such that guidance regarding a composition change operation is performed by tactile presentation by the tactile presentation unit 10 in the tactile presentation apparatus 20. Specifically, the control unit 21 is instructed for the tactile presentation for the guidance via the communication unit 5, and the control unit 21 causes the tactile presentation unit 10 in the tactile presentation apparatus 20 to execute the tactile presentation in accordance with the instruction.

Here, as an apparatus form of the tactile presentation apparatus 20, for example, an apparatus form of a type worn by a user, such as a smart watch or an eyeglass-type information processing apparatus that can communicate with the information processing apparatus 1A such as a smartphone or a tablet terminal, and an apparatus form such as a stand apparatus such as a tripod that assists the information processing apparatus 1A functioning as a camera are conceivable.

Note that the information processing apparatus 1A does not necessarily include the tactile presentation unit 10 in the imaging assistance system 100.

Furthermore, in the description given so far, the example has been described in which the guidance is provided for imaging by the camera including the screen that displays a through image, but it is also possible to apply a guidance technique as an embodiment to, for example, guidance regarding a camera having no screen that displays a through image such as an action camera.

Furthermore, in the description given so far, the vibration has been exemplified as an example of the tactile presentation for the guidance, but it is also possible to perform presentation other than the vibration, for example, air blowing and the like, as the tactile presentation.

### 13. Summary of Embodiments

As described above, an imaging assistance control apparatus (the information processing apparatus 1 or 1A) as an embodiment includes a control unit (the guidance control unit 7b or 7bA) that performs control such that guidance regarding a composition change operation by a user is performed by tactile presentation to the user on the basis of a difference between a target composition and an actual composition.

Therefore, it is possible to appropriately guide the composition change operation by the tactile presentation even in a case where guidance by a display is not suitable in a situation in which the user is not able to or is difficult to view a screen or even in a case where guidance by sound is not suitable.

Therefore, imaging assistance performance can be improved.

Furthermore, in the imaging assistance control apparatus as the embodiment, the control unit changes a mode of the tactile presentation for the guidance on the basis of a magnitude of the difference between the target composition and the actual composition.

Therefore, it is possible to cause the user to grasp whether the difference between the target composition and the actual composition becomes small or large depending on a difference in the mode of the tactile presentation for the guidance.

Therefore, even in a situation in which the user is not able to view or is difficult to view the screen, it is possible to improve the ease of achieving matching with the target composition, and the imaging assistance performance can be improved.

Moreover, in the imaging assistance control apparatus as the embodiment, the target composition is set as a composition which satisfies a condition that a target subject is arranged at a position set depending on an operation of the user in an image frame, an operation related to setting of an arrangement position of the target subject in the image frame is performed as a drawing operation on a screen (3a) displaying a through image of a captured image, and the control unit determines a setting condition excluding the arrangement position among setting conditions of the target composition in accordance with which of a plurality of operation classifications the drawing operation belongs to.

The operation classifications of the drawing operation are obtained by classifying operation modes that can be performed as the drawing operation, and examples thereof can include classifications of an operation of drawing a dot, an operation of drawing a circle, an operation of drawing an ellipse, and the like. Furthermore, the setting condition of the target composition means a condition for determining the composition of the target composition, and examples thereof include an arrangement position of the target subject in the image frame and a condition for setting a single target subject or multiple target subjects.

According to the configuration described above, the user can designate the arrangement position of the target subject and designate the setting condition excluding the arrangement position among the setting conditions of the target composition by one operation as the drawing operation on the screen.

Therefore, it is possible to reduce burden on the operation of the user.

Furthermore, in the imaging assistance control apparatus as the embodiment, the target composition is set as a composition which satisfies a condition that a target subject is arranged at a position set depending on an operation of the user in an image frame, and the control unit receives designation of the target subject by voice input from the user.

Therefore, there is no need for the user to operate an operator, such as a button or a touch panel, in the designation of the target subject.

Therefore, it is unnecessary for the user to search for the target subject on the screen or to search for an operator for designation when designating the target subject, which is suitable in a case where imaging is performed without gazing at the screen. In particular, a user interface suitable for people with visual impairment can be achieved.

Furthermore, in the imaging assistance control apparatus as the embodiment, the control unit receives a drawing operation on a screen displaying a through image of a captured image, and determines a situation of a camera obtaining the captured image and sets a composition satisfying a composition condition as the target composition in a case where the situation is a specific situation and a specific mark has been drawn by the drawing operation, the composition condition being associated with the situation and the drawn mark.

Therefore, in a situation in which the camera is in a specific situation, for example, in a theme park such as an amusement park, as a specific mark, for example, the mark imitating a famous character in the theme park, is drawn, it is possible to set, as the target composition, a composition which satisfies a composition condition associated with the situation and the mark, such as a composition in which a character is arranged at a position in the image frame corresponding to the drawn mark.

Therefore, a plurality of composition setting conditions can be performed by one operation called a mark drawing operation, and the burden on the operation of the user can be reduced.

Moreover, in the imaging assistance control apparatus as the embodiment, the target composition is set as a composition which satisfies a condition that a target subject is arranged at a position set depending on an operation of the user in an image frame, an operation of designating an arrangement range of the target subject in the image frame is performed as a drawing operation on a screen displaying a through image of a captured image, and the control unit determines a number of the target subjects to be arranged within the arrangement range in accordance with which of a plurality of operation classifications the drawing operation belongs to.

Therefore, the user can designate the arrangement range of the target subject and designate the number of target subjects to be arranged within the arrangement range by one operation as the drawing operation on the screen.

Therefore, it is possible to reduce burden on the operation of the user.

Furthermore, in the imaging assistance control apparatus as the embodiment, the target composition is set as a composition which satisfies a condition that a target subject is arranged at a target position in an image frame, and the control unit detects a movement of the target subject and controls guidance to arrange the target subject at the target position on the basis of the detected movement of the target subject.

Therefore, it is possible to perform the guidance in consideration of the movement of the target subject as the guidance for achieving the composition in which the target subject is arranged at the target position in the image frame.

Therefore, the accuracy of the guidance can be improved in accordance with the case where the target subject is the moving subject.

Furthermore, in the imaging assistance control apparatus as the embodiment, the control unit performs the guidance on the basis of a relationship between the target position and a predicted position of the target subject after a lapse of a predetermined time.

In a case where the movement of the target subject is large, if the guidance based on a difference between a current position of the target subject and the target position is performed, it is difficult to follow the movement of the target subject, and there may occur a situation in which the position of the target subject is hardly adjustable to match the target position. Therefore, the guidance is performed on the basis of the position after the lapse of the predetermined time predicted from the movement of the target subject as described above.

Therefore, the accuracy of the guidance can be improved in accordance with the case where the target subject is the moving subject.

Moreover, in the imaging assistance control apparatus as the embodiment, the control unit sets the target composition on the basis of the determination result of a scene to be imaged.

Therefore, it is possible to automatically set the target composition depending on the scene to be imaged, such as a scene of imaging a train at a station or a scene of imaging sunset, on the basis of the scene determination result.

Therefore, it is possible to reduce the operation burden on the user when performing imaging with an appropriate target composition depending on the scene to be imaged.

Furthermore, in the imaging assistance control apparatus as the embodiment, the target composition is set as a composition which satisfies a condition that a target subject is arranged at a target position in an image frame, and the control unit predicts a position at which the target subject is in a target state depending on the scene to be imaged, and controls the guidance such that the predicted position matches the target position.

Therefore, it is possible to appropriately assist the user such that the target subject in the target state is imaged with the target composition.

Therefore, it is possible to improve the user assist performance related to the composition change at the time of imaging.

Furthermore, in the imaging assistance control apparatus as the embodiment, the control unit enables a function of the guidance in a case where a situation in which the user is not viewing a screen displaying a through image of a captured image has been estimated.

Therefore, the guidance according to the present embodiment is automatically performed in a situation in which the user performs imaging without viewing the screen.

Therefore, it is possible to appropriately assist the user. Furthermore, it is possible to prevent the guidance function from being enabled even in a case where the guidance is unnecessary, such as a case where the user performs imaging while viewing the screen, so that it is possible to improve convenience.

Moreover, in the imaging assistance control apparatus as the embodiment, the target composition is set as a composition which satisfies a condition that a target subject is arranged in a target size at a target position in an image frame, and the control unit performs zoom control such that a size of the target subject becomes the target size.

Therefore, it is possible to eliminate the need for a zooming operation by the user in implementation of imaging with the target composition.

Therefore, it is possible to reduce burden on the operation of the user.

Furthermore, in the imaging assistance control apparatus as the embodiment, the control unit determines whether or not it is the situation in which the user is movable in the case of determining that it is not possible to adjust the size of the target subject to the target size by the zoom control, and causes the guidance for changing a positional relationship between the user and the target subject to be performed in a case of determining that it is the situation in which the user is movable.

Therefore, it is possible to prevent occurrence of an inconvenience such as causing the user to trouble surrounding people by performing the guidance even in a situation in which the user is not movable due to imaging in a crowd or the like, for example.

Therefore, it is possible to achieve appropriateness in assisting the user.

Furthermore, an imaging assistance control method as an embodiment is an imaging assistance control method including controlling, by an information processing apparatus, such that guidance regarding a composition change operation by a user is performed by tactile presentation to the user on the basis of a difference between a target composition and an actual composition.

With such an imaging assistance control method, it is also possible to obtain the similar functions and effects as those of the imaging assistance control apparatus as the embodiment described above.

An imaging assistance system (100) as an embodiment includes: a tactile presentation apparatus (20) including a tactile presentation unit (10) that performs tactile presentation to a user; and an imaging assistance control apparatus (the information processing apparatus 1A) including a control unit (the guidance control unit 7bA) that performs control such that guidance regarding a composition change operation by the user is performed by tactile presentation of the tactile presentation unit on the basis of a difference between a target composition and an actual composition.

With such an imaging assistance system, it is also possible to obtain functions and effects similar to those of the imaging assistance control apparatus as the embodiment described above.

Note that the effects described in the present specification are merely examples and are not limited, and there may be other effects.

### 14. Present Technology

The present technology can also have the following configurations.

(1)

An imaging assistance control apparatus including

a control unit that performs control such that guidance regarding a composition change operation by a user is performed by tactile presentation to the user on the basis of a difference between a target composition and an actual composition.

(2)

The imaging assistance control apparatus according to (1) above, in which

the control unit changes a mode of the tactile presentation for the guidance on the basis of a magnitude of the difference between the target composition and the actual composition.

(3)

The imaging assistance control apparatus according to (1) or (2) above, in which

the target composition is set as a composition which satisfies a condition that a target subject is arranged at a position set depending on an operation of the user in an image frame,

an operation related to setting of an arrangement position of the target subject in the image frame is performed as a drawing operation on a screen displaying a through image of a captured image, and

the control unit determines a setting condition excluding the arrangement position among setting conditions of the target composition in accordance with which of a plurality of operation classifications the drawing operation belongs to.

(4)

The imaging assistance control apparatus according to any one of (1) to (3) above, in which

the target composition is set as a composition which satisfies a condition that a target subject is arranged at a position set depending on an operation of the user in an image frame, and

the control unit receives designation of the target subject by voice input from the user.

(5)

The imaging assistance control apparatus according to any one of (1) to (6) above, in which

the control unit

receives a drawing operation on a screen displaying a through image of a captured image, and

determines a situation of a camera obtaining the captured image and sets a composition satisfying a composition condition as the target composition in a case where the situation is a specific situation and a specific mark has been drawn by the drawing operation, the composition condition being associated with the situation and the drawn mark.

(6)

The imaging assistance control apparatus according to any one of (1) to (5) above, in which

the target composition is set as a composition which satisfies a condition that a target subject is arranged at a position set depending on an operation of the user in an image frame,

an operation of designating an arrangement range of the target subject in the image frame is performed as a drawing operation on a screen displaying a through image of a captured image, and

the control unit determines a number of the target subjects to be arranged within the arrangement range in accordance with which of a plurality of operation classifications the drawing operation belongs to.

(7)

The imaging assistance control apparatus according to any one of (1) to (6) above, in which

the target composition is set as a composition which satisfies a condition that a target subject is arranged at a target position in an image frame, and

the control unit detects a movement of the target subject and controls guidance to arrange the target subject at the target position on the basis of the detected movement of the target subject.

(8)

The imaging assistance control apparatus according to (7) above, in which

the control unit performs the guidance on the basis of a relationship between the target position and a predicted position of the target subject after a lapse of a predetermined time.

(9)

The imaging assistance control apparatus according to (1) or (2) above, in which

the control unit sets the target composition on the basis of a determination result of a scene to be imaged.

(10)

The imaging assistance control apparatus according to (9) above, in which

the target composition is set as a composition which satisfies a condition that a target subject is arranged at a target position in an image frame, and

the control unit predicts a position at which the target subject is in a target state depending on the scene to be imaged, and controls the guidance such that the predicted position matches the target position.

(11)

The imaging assistance control apparatus according to any one of (1) to (10) above, in which

the control unit enables a function of the guidance in a case where a situation in which the user is not viewing a screen displaying a through image of a captured image has been estimated.

(12)

The imaging assistance control apparatus according to any one of (1) to (11) above, in which

the target composition is set as a composition which satisfies a condition that a target subject is arranged in a target size at a target position in an image frame, and

the control unit performs zoom control such that a size of the target subject becomes the target size.

(13)

The imaging assistance control apparatus according to (12) above, in which

the control unit

determines whether or not it is a situation in which the user is movable in a case of determining that the size of the target subject is not adjustable to the target size by the zoom control, and

causes the guidance for changing a positional relationship between the user and the target subject to be performed in a case of determining that it is the situation in which the user is movable.

(14)

An imaging assistance control method including

controlling, by an information processing apparatus, such that guidance regarding a composition change operation by a user is performed by tactile presentation to the user on the basis of a difference between a target composition and an actual composition.

(15)

An imaging assistance system including:

a tactile presentation apparatus including a tactile presentation unit that performs tactile presentation to a user; and

an imaging assistance control apparatus including a control unit that performs control such that guidance regarding a composition change operation by the user is performed by tactile presentation of the tactile presentation unit on the basis of a difference between a target composition and an actual composition.

### REFERENCE SIGNS LIST

1, 1A Information processing apparatus
2 Imaging unit
3 Display unit
3a Screen
4 Operation unit
5 Communication unit
6 Sensor unit
7, 7A Control unit
7a Image recognition processing unit
7b, 7bA Guidance control unit
8 Memory unit
9 Sound output unit
10 Tactile presentation unit
11 Bus
At Target area
Pt Target position
Ps Position of target subject
I1 Subject specifying information
15 Vibration device
20 Tactile presentation apparatus
21 Control unit
22 Communication unit
100 Imaging assistance system

1. An imaging assistance control apparatus comprising
a control unit that performs control such that guidance regarding a composition change operation by a user is performed by tactile presentation to the user on a basis of a difference between a target composition and an actual composition.

2. The imaging assistance control apparatus according to claim 1, wherein
the control unit changes a mode of the tactile presentation for the guidance on a basis of a magnitude of the difference between the target composition and the actual composition.

3. The imaging assistance control apparatus according to claim 1, wherein
the target composition is set as a composition which satisfies a condition that a target subject is arranged at a position set depending on an operation of the user in an image frame,
an operation related to setting of an arrangement position of the target subject in the image frame is performed as a drawing operation on a screen displaying a through image of a captured image, and
the control unit determines a setting condition excluding the arrangement position among setting conditions of the target composition in accordance with which of a plurality of operation classifications the drawing operation belongs to.

4. The imaging assistance control apparatus according to claim 1, wherein
the target composition is set as a composition which satisfies a condition that a target subject is arranged at a position set depending on an operation of the user in an image frame, and
the control unit receives designation of the target subject by voice input from the user.

5. The imaging assistance control apparatus according to claim 1, wherein
the control unit
receives a drawing operation on a screen displaying a through image of a captured image, and
determines a situation of a camera obtaining the captured image and sets a composition satisfying a composition condition as the target composition in a case where the situation is a specific situation and a specific mark has been drawn by the drawing operation, the composition condition being associated with the situation and the drawn mark.

6. The imaging assistance control apparatus according to claim 1, wherein
the target composition is set as a composition which satisfies a condition that a target subject is arranged at a position set depending on an operation of the user in an image frame,
an operation of designating an arrangement range of the target subject in the image frame is performed as a drawing operation on a screen displaying a through image of a captured image, and
the control unit determines a number of the target subjects to be arranged within the arrangement range in accordance with which of a plurality of operation classifications the drawing operation belongs to.

7. The imaging assistance control apparatus according to claim 1, wherein
the target composition is set as a composition which satisfies a condition that a target subject is arranged at a target position in an image frame, and
the control unit detects a movement of the target subject and controls guidance to arrange the target subject at the target position on a basis of the detected movement of the target subject.

8. The imaging assistance control apparatus according to claim 7, wherein
the control unit performs the guidance on a basis of a relationship between the target position and a predicted position of the target subject after a lapse of a predetermined time.

9. The imaging assistance control apparatus according to claim 1, wherein
the control unit sets the target composition on a basis of a determination result of a scene to be imaged.

10. The imaging assistance control apparatus according to claim 9, wherein
the target composition is set as a composition which satisfies a condition that a target subject is arranged at a target position in an image frame, and
the control unit predicts a position at which the target subject is in a target state depending on the scene to be imaged, and controls the guidance such that the predicted position matches the target position.

11. The imaging assistance control apparatus according to claim 1, wherein
the control unit enables a function of the guidance in a case where a situation in which the user is not viewing a screen displaying a through image of a captured image has been estimated.

12. The imaging assistance control apparatus according to claim 1, wherein
the target composition is set as a composition which satisfies a condition that a target subject is arranged in a target size at a target position in an image frame, and
the control unit performs zoom control such that a size of the target subject becomes the target size.

13. The imaging assistance control apparatus according to claim 12, wherein
the control unit
determines whether or not it is a situation in which the user is movable in a case of determining that the size of the target subject is not adjustable to the target size by the zoom control, and
causes the guidance for changing a positional relationship between the user and the target subject to be performed in a case of determining that it is the situation in which the user is movable.

14. An imaging assistance control method comprising
controlling, by an information processing apparatus, such that guidance regarding a composition change operation by a user is performed by tactile presentation to the user on a basis of a difference between a target composition and an actual composition.

15. An imaging assistance system comprising:
a tactile presentation apparatus including a tactile presentation unit that performs tactile presentation to a user; and
an imaging assistance control apparatus including a control unit that performs control such that guidance regarding a composition change operation by the user is performed by tactile presentation of the tactile presentation unit on a basis of a difference between a target composition and an actual composition.
